(19) United States
(12) Patent Application Publication
(10) Pub. No.: US 2009/0078774 A1
(43) Pub. Date: Mar. 26, 2009

(54) Graphical User Interface for Use in Programming a Barcode Reader

(75) Inventor: Duanfeng He, South Setauket, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 11/859,215

(22) Filed: Sep. 21, 2007

(51) Int. Cl. G06K 7/10

(52) U.S. Cl. 235/462.41

(57) ABSTRACT

An imaging-based bar code reader that includes an imaging and decoding system. Focusing optics and a sensor array define a field of view. A data processor has a memory for storing a pattern definition of previously imaged OCR characters and comparing a format of said previously stored characters to a present image to determine a character content of the present image.

### FIELD OF THE INVENTION

The present invention relates to an imaging-based bar code reader and, more particularly, to a bar code reader that captures 2-dimensional images.

### BACKGROUND OF THE INVENTION

Various electro-optical systems have been developed for reading optical indicia, such as bar codes. A bar code is a coded pattern of graphical indicia comprised of a series of bars and spaces having differing light reflecting characteristics. The pattern of the bars and spaces encode information. In certain bar codes, there is a single row of bars and spaces, typically of varying widths. Such bar codes are referred to as one dimensional (1D) bar codes. Other bar codes include multiple rows of bars and spaces, each row typically having the same width. Such bar codes are referred to as two dimensional (2D) bar codes.

Imaging systems include charge coupled device (CCD) arrays, complementary metal oxide semiconductor (CMOS) arrays, or other imaging pixel arrays having a plurality of photosensitive elements or pixels. An illumination system comprising light emitting diodes (LEDs) or other light source directs illumination toward a target object, e.g., a target bar code. Light reflected from the target bar code is focused through a lens of the imaging system onto the pixel array. Thus, an image of a field of view of the focusing lens is focused on the pixel array. Periodically, the pixels of the array are sequentially read out generating an analog signal representative of a captured image frame. The analog signal is amplified by a gain factor and the amplified analog signal is digitized by an analog-to-digital converter. Decoding circuitry of the imaging system processes the digitized signals and decodes the imaged bar code.

In many instances, a printed label designed to be scanned by a barcode scanner or reader may contain multiple barcodes. Often, the different barcodes contain different pieces of information and a combination of them provide information for filling a computer form. In some other cases, only one barcode within the printed label must be scanned. In the latter case, a “pick-list” mode of the scanner, not covered in this disclosure, may well be suited.

One traditional approach to solve the first mode of operation is to have an operator scan a sequence of barcodes. To prevent possible mix-ups between the multiple barcodes on the label, the barcodes printed on the target label may contain special tags, such as a leading letter “S” for serial number, to differentiate one barcode from the rest and allow the operator to choose the barcodes in a proper or specified order for subsequent formatting by the reader.

With imaging scanners, it is possible to scan many barcodes simultaneously (here the word “simultaneously” is understood from the user's point of view, meaning that for the user no perceivable effort, such as re-aiming of the scanner through motion, or re-arming the scanner through additional trigger-pulls, is required for the operation to complete; for the scanner, however, the multiple barcodes are likely decoded sequentially). While the decoding of multiple barcodes from one or more images by the scanner is relatively easy, the specification of which barcodes to expect, to decode, and to output may become difficult. When setting up the image reading process that allows the scanner to properly format the barcode data, if measurement data is gathered and programmed manually, it would be relatively labor-intensive and error-prone.

### SUMMARY OF THE INVENTION

A system for automatically and accurately evaluating bar codes contained in a target image includes an imaging system for creating a target image from a target including focusing optics and a sensor array. The focusing optics defines a field of view for focusing reflected illumination from an image onto the sensor array. A processor includes a memory for storing an image gathered from the sensor array having multiple bar codes spaced with respect to each other on the target in a predetermined format. A display presents data concerning the multiple bar codes on a viewing screen for use in programming an imaging-based reader for subsequent decoding and presentation of data conforming to the predetermined format.

These and other objects, advantages, and features of the exemplary embodiment of the invention are described in detail in conjunction with the accompanying drawings.

### BRIEF DESCRIPTION OF THE DRAWINGS

FIG. 1 is a perspective view of a bar code scanner supported on a stationary stand and connected to a desktop computer;

FIG. 2 is a schematic sectional view of a portion of the imaging-based bar code reader showing the scanner head;

FIG. 3 is a block circuit diagram of the imaging-based bar code reader of FIG. 1;

FIG. 4 is a plan view of a representative target label having multiple spaced bar codes representing different information; and

FIG. 5 is a plan view of an image of the label of FIG. 4 having a data window the overlies a part of the label image.

### DETAILED DESCRIPTION

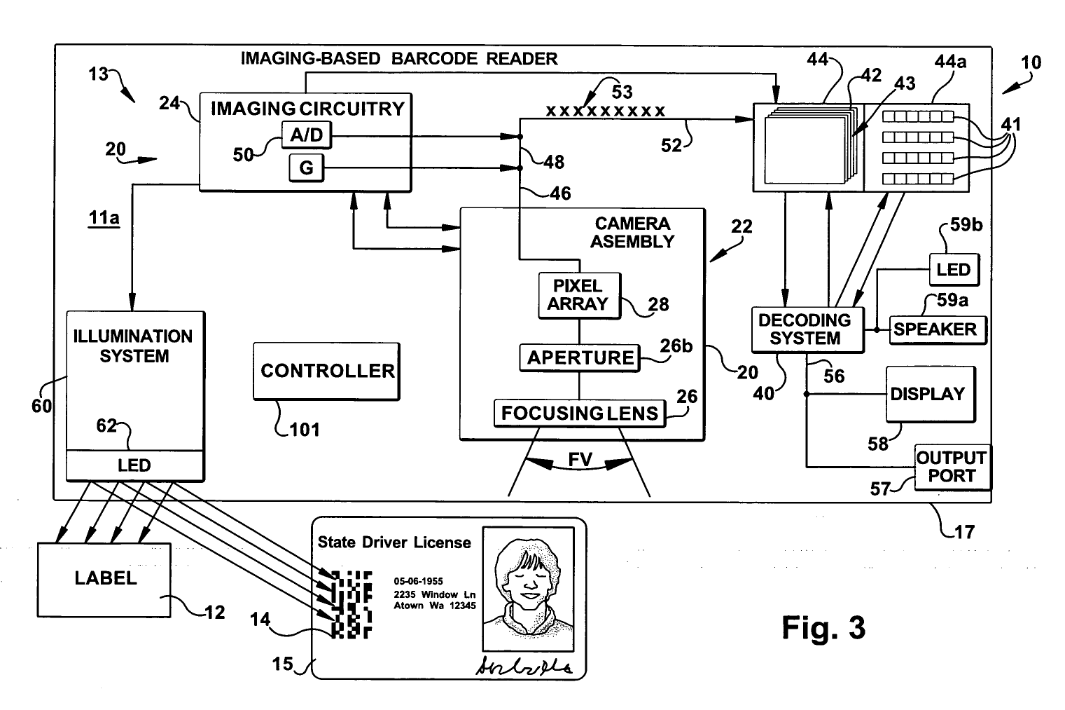

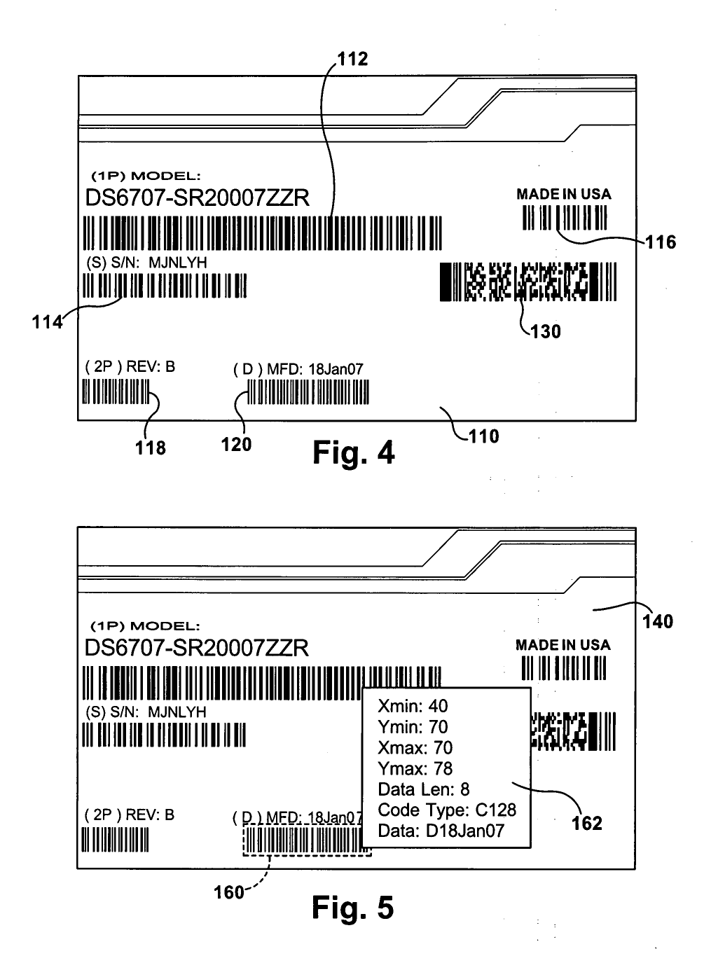

An imaging-based scanner or reader that is capable of reading bar codes is shown schematically at 10 in the Figures. The scanner 10 is capable of imaging and decoding bar codes. One example is the 2D bar code 14 in FIG. 3. Additionally, the reader 10 is also capable of capturing images such as an image or a document 110 in FIG. 4 that contains multiple bar codes. The bar code reader 10 includes a housing 11 supporting an imaging system 20 and a decoding system 40 (FIG. 3). The housing 11 supports a transparent window 17 through which reflected illumination from the target document is received by the imaging system 20.

When enabled, the imaging system 20 captures an image frame 42 of a field of view FV of the imaging system which is stored in a memory 44. The imaging process captures an image of the target bar code. The decoding system 40 analyzes a captured image frame 42 and attempts to decode decodable portions of the image frame 42. The decoded portions 41 of image frame 42 are stored in a buffer memory 44a. Alternately, a series of image frames 43 are captured and using a stitching method the decoding system 40 attempts to combine or stitch the decoded portions stored in buffer memory to achieve a full decode of the document 12 or 110.

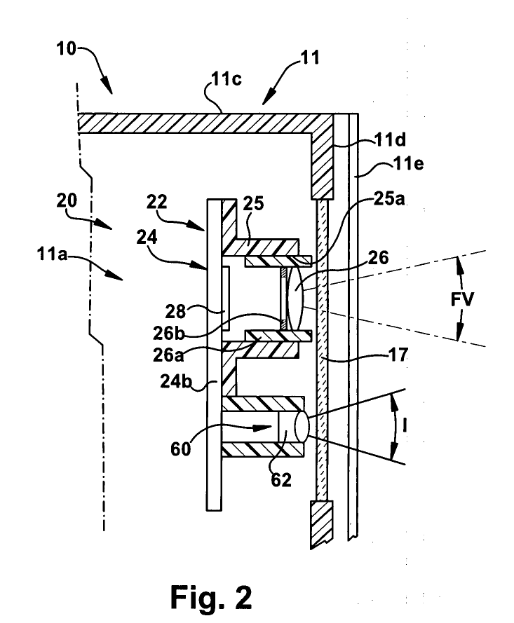

The imaging system 20 includes an imaging camera 22 (FIG. 2) and associated imaging circuitry 24. The imaging camera 22 includes a housing supporting focusing optics including a focusing lens 26 and a 2D photosensor or pixel array 28. The imaging camera 22 is enabled during an imaging session to capture a sequence of images of the field of view FV of the focusing lens 26.

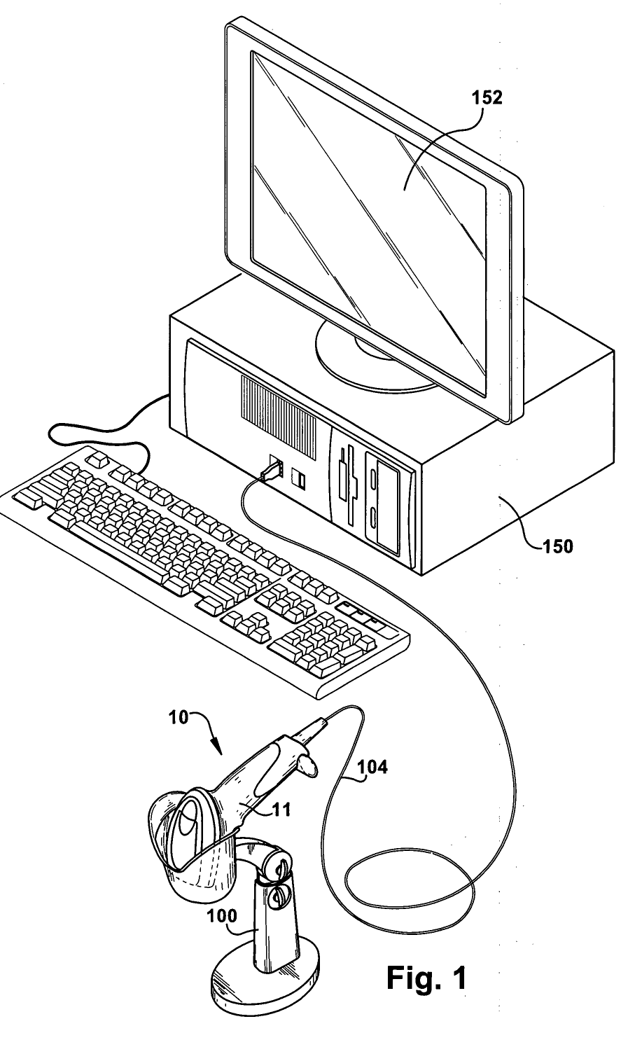

In one mode of operation, the bar code reader 10 is a hands-free reader including a housing having a flat base portion that can be placed on a counter or tabletop. The scanner 10 of FIG. 1 is supported by a support stand 100. When so mounted, the exposure operation mode of the camera can be altered enhance the image quality of the resulting image produced by the scanner 10.

The housing 11 defines an interior area 11a. Disposed within the interior area 11a circuitry 13 including the imaging and decoding systems 20, 40 and an illumination assembly 60 including one or more light emitting diodes 62 which, when enabled, direct illumination through the transparent window 17 and onto a target. The bar code reader circuitry 13 is electrically coupled to a power supply, which may be in the form of an on-board battery or a connected off-board power supply. If powered by an on-board battery, the reader 10 may be a stand-alone, portable unit. If powered by an off-board power supply, the reader 10 may have some or all of the reader's functionality provided by a connected host device.

Circuitry associated with the imaging and decoding systems 20, 40, including the imaging circuitry 24, may be embodied in hardware, software, electrical circuitry or any combination thereof and may be disposed within, partially within, or external to the camera assembly housing 25. In the illustrated embodiment, the functions of the reader are controlled and co-ordinated by a microprocessor controller 101. The controller 101 also manages outputs from the decoding system 40 such as an output 56 to a display 58 and communications output port 57 and visual and audible signals from an LED 59b and speaker 59a. The imaging camera housing 25 is supported with an upper or scanning head portion 11c of the housing and receives reflected illumination from the target document through the transparent window 17 supported by the scanning head 11c. The focusing lens 26 is supported by a lens holder 26a. The camera housing 25 defines a front opening 25a that supports and seals against the lens holder 26a so that the only illumination incident upon the sensor array 28 is illumination passing through the focusing lens 26.

Depending on the specifics of the camera assembly 22, the lens holder 26a may slide in and out within the camera housing front opening 25a to allow dual focusing under the control of the imaging circuitry 24 or the lens holder 26a may be fixed with respect to the camera housing 25 in a fixed focus camera assembly. The lens holder 26a is typically made of metal. A back end of the housing 25 may be comprised of a printed circuit board 24b, which forms part of the imaging circuitry 24 and may extend beyond the housing 25 to support the illumination system 60.

The imaging system 20 includes the sensor array 28 which may comprise a charged coupled device (CCD), a complementary metal oxide semiconductor (CMOS), or other imaging pixel array, operating under the control of the imaging circuitry 24. In one exemplary embodiment, the pixel array 28 comprises a two dimensional (2D) mega pixel array with a typical size of the pixel array being on the order of 1280×1024 pixels. The pixel array 28 is secured to the printed circuit board 24b, in parallel direction for stability.

As is best seen in FIG. 2, the focusing lens 26 focuses light reflected from the target bar code 14 through an aperture 26b onto the pixel/photosensor array 28. Thus, the focusing lens 26 focuses an image of the target document within the field of view FV onto the array of pixels comprising the pixel array 28. The focusing lens 26 field of view FV includes both a horizontal and a vertical field of view, the vertical field of view being shown schematically as FV in FIG. 2.

During an imaging session, one or more images in the field of view FV of the reader 10 may be obtained by the imaging system 20. An imaging session may be instituted by an operator, for example, pressing a trigger to institute an imaging session. Alternately, the imaging system 20 may institute an imaging session when a lower or bottom edge of the item 15 moves through an upper portion of the field of view FV. Yet another alternative is to have the imaging system 30 always operational such that image after image is captured and analyzed for the presence of data within an imaged target. In any event, the process of capturing an image 42 of the field of view FV during an imaging session is known in the scanner art. Electrical signals are generated by reading out of some or all of the pixels of the pixel array 28 after an exposure period. After the exposure time has elapsed, some or all of the pixels of pixel array 28 are successively read out, thereby generating an analog signal 46. In some sensors, particularly CMOS sensors, all pixels of the pixel array 28 are not exposed at the same time, thus, reading out of some pixels may coincide in time with an exposure period for some other pixels.

The analog image signal 46 from the pixel array represents a sequence of photosensor voltage values, the magnitude of each value representing an intensity of the reflected light received by a photosensor/pixel during an exposure period. The analog signal 46 is amplified by a gain factor, generating an amplified analog signal 48. The imaging circuitry 24 further includes an analog-to-digital (A/D) converter 50. The amplified analog signal 48 is digitized by the A/D converter 50 generating a digitized signal 52. The digitized signal 52 comprises a sequence of digital gray scale values 53 typically ranging from 0-255 (for an eight bit processor, i.e., 2⁸=256), where a 0 gray scale value would represent an absence of any reflected light received by a pixel (characterized as low pixel brightness) and a 255 gray scale value would represent a very intense level of reflected light received by a pixel during an integration period (characterized as high pixel brightness).

### Target Label Interpretation

The exemplary image based scanner 10 can capture an image 42 such as an image of a target label 110 illustrated in FIG. 4 having multiple bar codes printed thereon. The label shown in FIG. 4 is a shipping label used in shipping a product such as an image based scanner or bar code reader. The label contains five 1D barcodes 112, 114, 116, 118, 120, namely one each for the model number, serial number, country of origin, revision number, and manufacture date. In addition, there is also a 2D barcode 130 containing both the model and serial numbers. In accordance with the exemplary system it is desirable to get several pieces of data from a single image either with or without the aid of stitching within the scanner 10.

In the preferred embodiment, to program one or more such scanners, an operator performs the following steps:
1. S/he opens a special computer program executing on a computer 150 and connects the program with a communications protocol running on an image capturing device, possibly the scanner 10. The communications between the computer and the scanner occur over a cable 104 connected to the communications port 57 on the scanner and a communications port, such as a USB port on the computer 150. The computer program, in turn, puts the scanner into a special mode in which an image 140 (FIG. 5) of the label 110 is obtained and transmitted to the computer.
2. S/he operates the scanner 10 to obtain such an image 140. This step may be performed with a video-preview on the computer, and/or it can be repeated until the acquired image meets a certain criteria, either judged by the scanner 10, the computer program executing on the computer 150, or the operator.
3. S/he works with the computer program, which now displays the captured image of the printed label. When the cursor is moved to select a barcode, the computer program automatically performs certain tasks on the barcode. These tasks include highlighting an outline 160 of the barcode and displaying the barcode's decoded results such as the code type and the decoded data content in a window 162. Alternatively, the information relating to each barcode in the image could be displayed statically, either in the image itself, or in a separate text area on the computer screen or monitor 152 with markers, such as numbers or letters, linking them to the barcodes in the image.
4. With the help of the computer program, the operator constructs processing logic for use in programming the scanner 10 with the barcodes in view, utilizing each barcode's properties.

The properties utilized in the scanner logic may include the barcode's physical size (as measured relatively to the image), its location co-ordinates relative to a reference point of the image, its data size, its code type, part of its data content (such as the leading letter “S” for serial number), etc. The size and coordinate values, described as relative ones here, are in relation to each other, and are independent of the orientation and size they represent in the actual image.

The window 162 of FIG. 5 shows data generated as context data when a user moves the computer cursor over the barcode near the bottom-center of the image. A part of the context data can be used by the user in programming the desired behavior of the imaging barcode scanner. While the image itself is sometimes in grayscale only, the highlighting, shown here as a dashed rectangular box around the barcode under review, can be better viewed when displayed in color.

The logic specified for the scanning procedure may be straightforward such as output order and pre- and postfixes attached to the barcodes, or complex ones such as the scanning operation must be able to produce the data for the manufacture data, revision number and serial number, while the serial number can be obtained from either from either a 1D or 2D barcode. The output is typically formatted in the form of a string with delimiters for the different bar codes that is output as a string from the communications port 57 of the bar code reader.

The data available from a bar code containing target is used to program the bar code reader for subsequent use. More specifically, the data is used by a person in storing a signature for a target label into the reader for subsequent scanning. This means that once the makeup of a bar code label and its processing logic is determined it will be transmitted to one or more barcode scanners to generate a desired output when scanning this type of target label. The programming of the one or more such barcode scanners can be through wired or wireless electronic communication, or through the use of one or more programming barcodes.

When using one or more programming barcodes (either 1D or 2D, each bar code bears special codes to differentiate them from “normal” data-carrying barcodes). They are produced by the computer program running on the computer 150. These barcodes are scanned by each scanner which must be programmed to scan target labels with the specified format.

More than one such label can be specified at a time in each scanner, if the barcode specifying properties can uniquely identify not only a barcode (or a group of barcodes) is within a target label, but also uniquely identify a barcode (or a group of barcodes) is within one of a set of target labels.

The system for capturing and decoding can be different from the disclosed exemplary embodiment for the purpose of GUI programming. The capturing can be by a camera, such as a high quality webcam and decoding could be done by the computer 150. Its only when one is programming a scanner that a scanner need be attached to the computer and only if the programming is done through the communications link between them such as a USB port connection. Of course an imaging scanner can be used to capture and decode the bar codes of a target image. In the exemplary embodiment, however, the decoding is done by the computer attached to the scanner that implements the GUI so that only an image of the target is transmitted to the computer 150 rather than data from the bar codes.

While the present invention has been described with a degree of particularity, it is the intent that the invention includes all modifications and alterations from the disclosed design falling within the spirit or scope of the appended claims.

We claim:

1. Apparatus for evaluating bar codes contained in a target image comprising:
a) an imaging system for creating a target image from a target including focusing optics and a sensor array, the focusing optics defining a field of view for focusing reflected illumination from a target onto the sensor array; and
b) a processor including a memory for storing an image gathered from the sensor array having multiple bar codes spaced with respect to each other on the target in a predetermined format;
c) a display for presenting data concerning the multiple bar codes on a viewing screen for use in creating a programming logic for an imaging-based reader for subsequent decoding of bar codes conforming to the predetermined format.

2. The apparatus of claim 1 wherein the imaging system and processor are part of a hand held bar code scanner or reader and further comprising a communications interface for conveying image data to a remote computer that presents the data concerning the bar codes on a viewing screen.

3. The apparatus of claim 1 wherein the display depicts an image of the target and includes a user interface that allows a user to select a chosen one of the multiple bar codes.

4. The apparatus of claim 3 wherein the user interface allows an operator to maneuver a cursor relative the target image to displays information relative to a bar code selected with said cursor.

5. The apparatus of claim 4 wherein the display opens a window having data contained within the window indicating a position relative to a reference of an associated bar code contained within said image when the cursor is moved to a position overlying said associated bar code.

6. The apparatus of claim 4 wherein the display highlights a chosen bar code when the when the cursor is moved to a position overlying said chosen bar code.

7. The apparatus of claim 6 wherein the chosen bar code has a bounding box placed around it to highlight the chosen bar code.

8. The apparatus of claim 4 wherein the bar code is decoded and textual data representing the bar code is displayed.

9. The apparatus of claim 1 wherein the processor formats a programming bar code and the imaging system comprises a bar code reader for reading the programming bar code and programming a format of the target image from which the programming bar code derives.

10. A method of reading a target with an imaging based reader comprising:
a) providing an imaging and decoding system for imaging a single target having focusing optics and a sensor array, the focusing optics defining a field of view for focusing reflected illumination from the target onto the sensor array;
b) creating an image of a target having multiple spaced bar codes arranged on the target in a predetermined format; and
c) displaying data from the spaced bar codes on a display for programming the imaging based reader to enable reading and decoding multiple bar codes arranged with respect to each other in the predetermined format.

11. The method of claim 10 wherein the display depicts a target image of the target and further includes providing a user interface and allowing a user to select a chosen one of the multiple bar codes for displaying the data for use in programming the imaging based reader.

12. The method of claim 11 wherein the user interface allows an operator to maneuver a cursor relative the target image to displays information relating to a bar code selected by the user.

13. The method of claim 12 wherein the display opens a window having data contained within the window indicating a position relative to a reference of an associated bar code contained within said image by moving the cursor to a position overlying said associated bar code.

14. The method of claim 10 wherein the display highlights a chosen bar code when the when the cursor is moved to a position overlying said chosen bar code.

15. The method of claim 14 wherein a bounding box is displayed around the chosen bar code to highlight the chosen bar code.

16. The method of claim 10 wherein a selected bar code is decoded and textual data representing the selected bar code is displayed.

17. The method of claim 10 additionally comprising formatting a programming bar code having data for use in programming a bar code reader.

18. Apparatus for reading a target comprising:
a) imaging means for imaging a target having multiple target bar codes, said imaging means including focusing optics and a sensor array and processing electronics for processing signals from the sensor array, the focusing optics defining a field of view and focusing reflected illumination from the target onto the sensor array;
b) processor means including a memory for storing an image gathered from the sensor array having multiple bar codes spaced with respect to each other on the target; and
c) display means for presenting data concerning the multiple bar codes on a viewing screen for use in programming the imaging-based reader.

19. The apparatus of claim 18 wherein the display means includes a video output means for presenting a cursor on a video display and control means for moving the cursor in relation to the multiple target bar codes for selecting one of said bar codes.

20. The apparatus of claim 19 display means highlights a selected bar code.
